(19) United States
(12) Patent Application Publication
(10) Pub. No.: US 2008/0014557 A1
(43) Pub. Date: Jan. 17, 2008

(54) DENTAL IMPLANT SYSTEM COMPONENT HAVING A COATING

(75) Inventors: KLAUS-DIETER KUHN, MARBURG-ELNHAUSEN (DE); SEBASTIAN VOGT, ERFURT (DE); SANDRA MARTINOVIC, FRANKFURT (DE)

Correspondence Address: NORRIS, MCLAUGHLIN & MARCUS, PA, 875 THIRD AVENUE, 18TH FLOOR, NEW YORK, NY, 10022, US

(73) Assignee: HERAEUS KULZER GMBH, HANAU (DE)

(21) Appl. No.: 11/778,191

(22) Filed: Jul. 16, 2007

(30) Foreign Application Priority Data
Jul. 17, 2006 (DE) 10 2006 033 312.8

(51) Int. Cl. A61C 8/00; C09K 3/00

(52) U.S. Cl. 433/201.1; 106/35

(57) ABSTRACT

A dental implant system component having a coating made of an only slightly water-soluble chlorhexidine fatty acid salt, in which one or more antiphiogistics and/or one or more steroids and/or one or more prostaglandins and/or one or more bisphosphonates and/or one or more statins are dissolved.

The subject matter of the present invention is a dental implant system component having a coating.

The term “dental implant system component” is understood to mean healing caps, gingiva formers, connection elements, implant bodies, and implant superstructures.

Implant system components can, as a matter of principle, be subdivided in 2 groups: non-exchangeable components that remain lastingly attached in the bone (e.g. the implant body) and exchangeable components that can be inserted and exchanged according to the treatment phase (e.g. the gingiva formers).

In dental implantology, it is common after implantation of the implant body in the jaw bone to seal the implant body during the healing phase using a healing cap. Alternatively, an implant may as well heal transgingival or open. After the healing phase is complete, which may take up to six months, the healing cap is removed and replaced by a gingiva former for final healing and formation of the soft tissue. Once final healing and formation of the soft tissue are complete, the gingiva former is removed and a definitive implant superstructure is placed on the implant body. The terms “abutment,” “build-up post,” “implant post,” and “insert” are synonyms for the term “implant superstructure.”

After the implant body is implanted, microbial growth may spread from the oral cavity to the surfaces of implant body and healing cap and, at a later point in time, of the gingiva former.

In its early phase, the microbial growth may lead to inflammation around the implant body which, if minor, may lead to a limited loss of bone in crestal location and, if major, may lead to the implant being lost entirely. Crestal bone loss is the more common complication of these two.

In the long term, microbial growth on the implant surfaces may lead to periimplantation mucositis, which also can have bone loss and, in the extreme case, loss of the implant as its corollaries.

In the early phase, this is an acute inflammation reaction while chronic mechanisms play an increasing role later on.

In order to prevent these processes, it is desirable to use dental implant system components whose surface is protected from the spread of microbial growth. Moreover, it is also desirable to prevent inflammatory processes from occurring in the close vicinity of dental implant system components during the early healing phase.

The invention has as its object to provide a dental implant system component that improves tissue healing in the patient and prevents inflammation to the extent possible.

The object is met according to the invention by the features described herein. A dental implant system component has been developed in which the dental implant system component is coated by a layer containing at least one only slightly water-soluble chlorhexidine fatty acid salt, in which one or more antiphlogistics and/or one or more steroids and/or one or more prostaglandins and/or one or more bisphosphonates and/or one or more statins are dissolved, whereby the layer preferably reacts alkaline or pH-neutral in water. The invention is based on the surprising finding that chlorhexidine fatty acid salts can form layers and that non-steroidal and steroidal antiphlogistics, amongst other substances, can dissolve in chlorhexidine fatty acid salts. The particular advantage of the implant system component according to the invention is that the geometry and substance composition of the healing caps and gingiva formers can be variable since the layer adheres to a wide variety of surfaces. The invention provides an implant component that is protected from microbial growth for a period of several days to several weeks. The dental implant system component shall preferably be provided to be antiseptic at its surface only.

It is advantageous to use chlorhexidine laurate, chlorhexidine myristate, chlorhexidine palmitate and/or chlorhexidine stearate as chlorhexidine fatty acid salts. These chlorhexidine fatty acid salts are only slightly soluble in water and release chlorhexidine for a period of several days to weeks in an aqueous environment. The low solubility is advantageous in that only the surface of the implant system component is antimicrobially protected and in that no major amounts of chlorhexidine are released in the vicinity of the temporary dental implant materials.

It is preferred to use ibuprofen, indomethacin and/or diclofenac as antiphlogistics. It is also advantageous to provide the antiphlogistics in their acid form. The acid forms of these antiphlogistics dissolve in chlorhexidine fatty acid esters, whereas the alkali salt forms of these antiphlogistics are insoluble in chlorhexidine fatty acid salts. The acid forms of the antiphlogistics are advantageous as compared to the salt forms in that they are only slightly soluble in water or an aqueous environment. This provides for delayed release of the antiphlogistics from the layer-forming chlorhexidine fatty acids salts in the presence of water or an aqueous environment.

Moreover, it is useful to use corticosteroids and/or estrogens as steroids. It is particularly preferred to use triamcinolone, dexamethasone and/or estradiol as steroids. These steroids are also soluble in chlorhexidine fatty acid salts and only slightly soluble in an aqueous environment. Other corticosteroids, including betamethasone, methylprednisolone, prednisone, prednisolone, cortisone and/or hydrocortisone, may be used as well.

The invention also provides for prostaglandins to be contained in the layer. Acting in conjunction with antiphlogistic agents, prostaglandins can have synergistic effects. It is advantageous to use prostaglandin E2.

The scope of the invention also includes bisphosphonates being contained in the coating. In this context, the bisphosphonates are preferably provided in their acid form. The bisphosphonate, aledronate, is particularly preferred.

It is advantageous to use simvastatin and/or lovastatin as statins in the coating.

The invention is illustrated by means of the following examples without limiting the generality of its scope.

### EXAMPLE 1

The mucosal membrane-facing surfaces of a healing cap previously heated to 70° C. that has a mass of 793.6 mg and is made of titanium are sprayed with a 5% ethanolic solution of chlorhexidine palmitate in which 1% ibuprofen is dissolved. A transparent layer is thus formed. The mass of the coating is 2.1 mg.

### EXAMPLE 2

The mucosal membrane-facing surfaces of a healing cap previously heated to 70° C. that has a mass of 766.9 mg and is made of titanium are sprayed with a 5% ethanolic solution of chlorhexidine palmitate in which 1% diclofenac is dissolved. A transparent layer is thus formed. The mass of the coating is 1.7 mg.

### EXAMPLE 3

The mucosal membrane-facing surfaces of a healing cap previously heated to 70° C. that has a mass of 753.9 mg and is made of titanium are sprayed with a 5% ethanolic solution of chlorhexidine palmitate in which 1% prostaglandin E2, which acts selectively on EP4 receptors, is dissolved. A transparent layer is thus formed.

### EXAMPLE 4

The mucosal membrane-facing surfaces of a healing cap previously heated to 70° C. that has a mass of 791.39 mg and is made of titanium are sprayed with a 5% ethanolic solution of chlorhexidine palmitate in which 1% simvastatin is dissolved. A transparent layer is thus formed.

### EXAMPLE 5

The mucosal membrane-facing surfaces of a healing cap previously heated to 70° C. that has a mass of 791.39 mg and is made of titanium are sprayed with a 5% ethanolic solution of chlorhexidine palmitate in which 1% aledronate is dissolved. A transparent layer is thus formed.

### EXAMPLE 6

The mucosal membrane-facing surfaces of a healing cap previously heated to 70° C. that has a mass of 791.39 mg and is made of titanium are sprayed with a 5% ethanolic solution of chlorhexidine palmitate in which 1% dexamethasone is dissolved. A transparent layer is thus formed.

### EXAMPLE 7

The mucosal membrane-facing surfaces of a healing cap previously heated to 70° C. that has a mass of 791.39 mg and is made of titanium are sprayed with a 5% ethanolic solution of chlorhexidine palmitate in which 1% estradiol is dissolved. A transparent layer is thus formed.

What is claimed is:

1. Dental implant system component having a coating made of an only slightly water-soluble chlorhexidine fatty acid salt, in which one or more antiphlogistics and/or one or more steroids and/or one or more prostaglandins and/or one or more bisphosphonates and/or one or more statins are dissolved.

2. Dental implant system component according to claim 1, wherein the chlorhexidine fatty acid salt is selected from the group consisting of chlorhexidine laurate, chiorhexidine myristate, chiorhexidine palmitate and chlorhexidine stearate.

3. Dental implant system component according to claim 1, wherein the coating reacts alkaline or pH-neutral in water.

4. Dental implant system component according to claim 1, wherein the coating contains one or more dissolved antiphlogistics selected from the group consisting of ibuprofen, indomethacin and diclofenac.

5. Dental implant system component according to claim 4, wherein the antiphlogistics are provided in their acid form.

6. Dental implant system component according to claim 1, wherein the coating contains one or more dissolved steroids selected from the group consisting of corticosteroids and estrogens.

7. Dental implant system component according to claim 6, wherein the steroids are selected from the group consisting of triamcinolone, dexamethasone and estradiol.

8. Dental implant system component according to claim 1, wherein the coating contains dissolved prostaglandin E2.

9. Dental implant system component according to claim 1, wherein the coating contains dissolved aledronate.

10. Dental implant system component according to claim 9, wherein the aledronate is provided in its acid form.

11. Dental implant system component according to claim 1, wherein the coating contains one or more dissolved statins selected from the group consisting of lovastatin and simvastatin.

12. An oral care method comprising inserting a dental implant system component according to claim 1 into jawbone.
